(19) United States
(12) Patent Application Publication
(10) Pub. No.: US 2008/0094831 A1
(43) Pub. Date: Apr. 24, 2008

(54) PLANE LIGHT-SOURCE DEVICE

(75) Inventor: Shigeyuki MATSUMOTO, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Mitsubishi Electric Corporation, Chiyoda-ku (JP)

(21) Appl. No.: 11/866,104

(22) Filed: Oct. 2, 2007

(30) Foreign Application Priority Data
Oct. 18, 2006 (JP) 2006-283725

(51) Int. Cl. G02B 5/02

(52) U.S. Cl. 362/235

(57) ABSTRACT

A plane light-source device having lamps disposed behind a diffuser is provided in which influences of heat and electromagnetic waves generated by the lamps are suppressed and the lamps are prevented from being broken on drop impact. A plane light-source device (a direct-type backlight) of a liquid-crystal display apparatus includes a plurality of lamps disposed side by side with a given pitch, a diffuser for diffusing light from the lamps, and metal covers disposed between the diffuser and the lamps. The metal covers each have a plurality of through holes, and they reflect light from the lamps at their respective surfaces that face the lamps.

### BACKGROUND OF THE INVENTION

1. Field of the Invention

The present invention relates to a plane light-source device that is used, e.g. as a backlight of a liquid-crystal display apparatus, and particularly to a technique to provide a plane light-source device with reduced thickness and uniform luminance.

2. Description of the Background Art

A non-light-emitting transmissive image display panel, such as a liquid-crystal display panel (a liquid-crystal panel), uses a plane light-source device called a backlight, which is provided in the rear of the display panel to radiate uniform light to the display surface. In general, such a backlight uses small-diameter cylindrical fluorescent tubes as light sources (hereinafter referred to as “lamps”), such as cold-cathode tubes or hot-cathode tubes. Known backlight structures include an edge-light type in which a lamp is disposed at an edge of a light guide plate, and a direct type in which a reflecting plate (hereinafter referred to as “a reflector”) and lamps are accommodated in a frame and a light-transmitting diffuser (hereinafter referred to as “a diffuser”) for diffusing light is provided at the opening of the frame.

In the direct-type backlight structure, the lamps and reflector are disposed behind the diffuser, and the diffuser diffuses direct light from the lamps and reflected light from the reflector to emit plane light with uniform luminance. This structure is advantageous in providing a higher-luminance light-emitting surface because the structure allows use of an increased number of lamps.

Conventionally, liquid-crystal display apparatuses (liquid-crystal displays) have been applied mainly to the monitors of apparatuses like computer information terminals, personal computers, mobile electronic devices and the like, and the liquid-crystal displays chiefly used edge-light type backlight devices. However, recently, higher-luminance backlight devices are needed because of the developments of liquid-crystal displays with wider viewing angles and enhanced luminance, and their increasing applications to video display apparatuses typically including television receivers. Accordingly, there are demands for development of higher-luminance direct-type backlight devices with reduced thickness and enhanced luminance uniformity.

However, direct-type backlights have the following problems: the luminance locally increases right above the individual lamps, and so the light-emitting surface exhibits non-uniform luminance; the temperature is considerably elevated by the heat generated by the lamps, and so the lamps may suffer deterioration of luminous efficiency; and the temperature gradient in the liquid-crystal display panel (hereinafter referred to as “a liquid-crystal panel”) becomes large because of the heat generated by the lamps, and so the display quality deteriorates. Furthermore, the lamps emit light at high frequencies and so the electromagnetic waves generated by the lamps interfere with driving frequencies of the liquid-crystal display elements, leading to deterioration of display quality. These problems become more serious especially when the backlights are constructed thinner.

In a common conventional technique for enhancing the luminance uniformity of the direct-type backlight devices, a zebra-like light-quantity correcting pattern, called a light screen, is printed on the diffuser (e.g. a sheet of polyethylene terephthalate (PET)). This technique enhances the luminance uniformity by reducing the quantity of light that is emitted right above the lamps. Also, there are various other techniques for obtaining uniform luminance without using such light screen printing (for example, see Japanese Patent Application Laid-Open Nos. 9-138398 (1997), 5-333333 (1993) and 2000-338895, which are hereinafter referred to respectively as Patent Documents 1, 2 and 3).

For example, in Patent Document 1, the thickness of the diffuser is assigned weights to obtain uniform luminance at the light-emitting surface. In Patent Document 2, two perpendicular prism plates are disposed between a lamp and diffuser to obtain uniform luminance. In Patent Document 3, luminance control means of transparent resin is provided above the lamps.

Also, in methods proposed to prevent deterioration of display quality of liquid-crystal panels caused by electromagnetic waves generated by the lamps, an electromagnetic blocking member composed of a transparent film and a transparent electro-conductive film formed thereon is provided between the lamps and diffuser (for example, see Japanese Patent Application Laid-Open No. 5-264991 (1993), which is hereinafter referred to as Patent Document 4), or an electro-conductive sheet composed of a transparent film and a thin metal film deposited thereon is wound around the lamp (for example, see Japanese Utility Model Application Laid-Open No. 4-37977 (1992), which is hereinafter referred to as Patent Document 5).

Conventional direct-type backlights as plane light-source devices are thicker than sidelight-type backlights because the lamps are arranged side by side behind the diffuser, and it is originally difficult to reduce the thickness of the direct-type backlights. Also, reducing the distance between the diffuser and lamps to reduce the thickness causes an intensive lamp image to appear at the light-emitting surface of the diffuser (an image of the lamps in which the luminance is high right above the lamps and low between the lamps), which deteriorates light-emission quality.

The lamp image can be alleviated by shortening the intervals between the lamps (lamp pitch), but then the number of required lamps is increased to worsen the problems caused by heat generated from the lamps. That is, in conventional direct-type backlights, the diffuser is made of synthetic resin, such as acrylic resin, polycarbonate, or polyethylene terephthalate, so that the diffuser will be warped, yellowed, or deformed by the heat from the lamps, which deteriorates the light-emission quality and shortens the lifetime of the device. Accordingly, the direct-type backlights have to be constructed thicker in proportion to the lamp pitch. Such problems caused by heat generation occur in the same way also when an increased number of lamps are used to obtain higher luminance.

In this way, in direct-type backlights using synthetic resin diffusers, it is necessary to dispose the lamps and diffuser at a longer distance in order to avoid the occurrence of a lamp image and problems caused by heat generation of the lamps. It is therefore difficult to reduce the thickness of the device and obtain higher light-emission luminance.

In a known technique for realizing thinner backlights, the diffuser is made of glass with high heat resistance so that the distance between the lamps and diffuser can be shortened (for example, see Japanese Patent Application Laid-Open No. 2004-127643). However, this technique does not dissipate heat from the lamps out of the backlight, and so the temperature in the backlight unavoidably increases. This will lead to reduced luminous efficiency of the lamps and increased temperature gradient in the liquid-crystal panel, and hence to deterioration of display quality.

Furthermore, as mentioned above, in liquid-crystal display apparatuses using direct-type backlights, reducing the distance between the lamps and liquid-crystal panel causes the liquid-crystal panel to be affected by electromagnetic waves generated by the lamps, which also leads to deterioration of display quality. This problem can be solved by disposing an electromagnetic wave blocking member or an electro-conductive sheet around the lamps as described in Patent Documents 4 and 5, but the electromagnetic wave blocking member or electro-conductive sheet may be deformed by the heat from the lamps, or they may hinder heat dissipation and accelerate the elevation of temperature of the lamps.

Moreover, as compared with sidelight-type backlights, the direct-type backlights are more likely to suffer deformation and breakage of the lamps on drop impact.

### SUMMARY OF THE INVENTION

The present invention has been made to solve the problems described above, and an object of the present invention is, in a plane light-source device such as a direct-type backlight having lamps arranged behind a diffuser, to suppress influences of heat and electromagnetic waves generated by the lamps and to prevent breakage of the lamps on drop impact.

A plane light-source device according to the present invention includes a plurality of lamps and a diffuser for diffusing light from the lamps. Covers are disposed between the diffuser and the lamps and respectively cover the plurality of lamps. A rear frame is disposed in a position that faces toward the diffuser, with the lamps interposed between them. The rear frame is made of a metal material. The covers are made of a metal material or a resin material with metal particles mixed therein, and the covers each have a plurality of through holes and are fixed to the rear frame.

The covers reflect part of direct light propagating from the lamps toward the diffuser, so that a lamp image is less likely to appear at the light-emission surface of the diffuser. Also, the covers dissipate heat generated by the lamps and suppress heat conduction to the diffuser, thus preventing the diffuser from being warped, yellowed, or deformed by heat. Accordingly, the light-emission quality is less likely to deteriorate even when the distance between the diffuser and the lamps is reduced, which allows reduction of the thickness of the plane light-source device. Also, the covers are made of metal material or resin material with metal particles mixed therein, so that they can block electromagnetic waves generated by the lamps. Furthermore, the covers absorb heat generated by the lamps and dissipate it to the rear frame made of metal. As a result, in the liquid-crystal display apparatus using the plane light-source device, it is possible to suppress deterioration of display quality due to influences of electromagnetic waves and heat generated by the lamps.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view roughly illustrating the structure of a liquid-crystal display apparatus according to the present invention;

FIG. 2 is a cross-sectional view of the liquid-crystal display apparatus according to a first preferred embodiment of the present invention;

FIG. 3 is a perspective view of a metal cover of the liquid-crystal display apparatus of the first preferred embodiment;

FIG. 4 is a three-view drawing of the metal cover of the liquid-crystal display apparatus of the first preferred embodiment;

FIG. 5 is a perspective view of a metal cover according to a second preferred embodiment;

FIG. 6 is a three-view drawing of the metal cover of the second preferred embodiment;

FIG. 7 is a diagram used to describe an effect of the second preferred embodiment; and

FIG. 8 is a cross-sectional view of a liquid-crystal display apparatus according to a third preferred embodiment.

### DESCRIPTION OF THE PREFERRED EMBODIMENTS

### First Preferred Embodiment

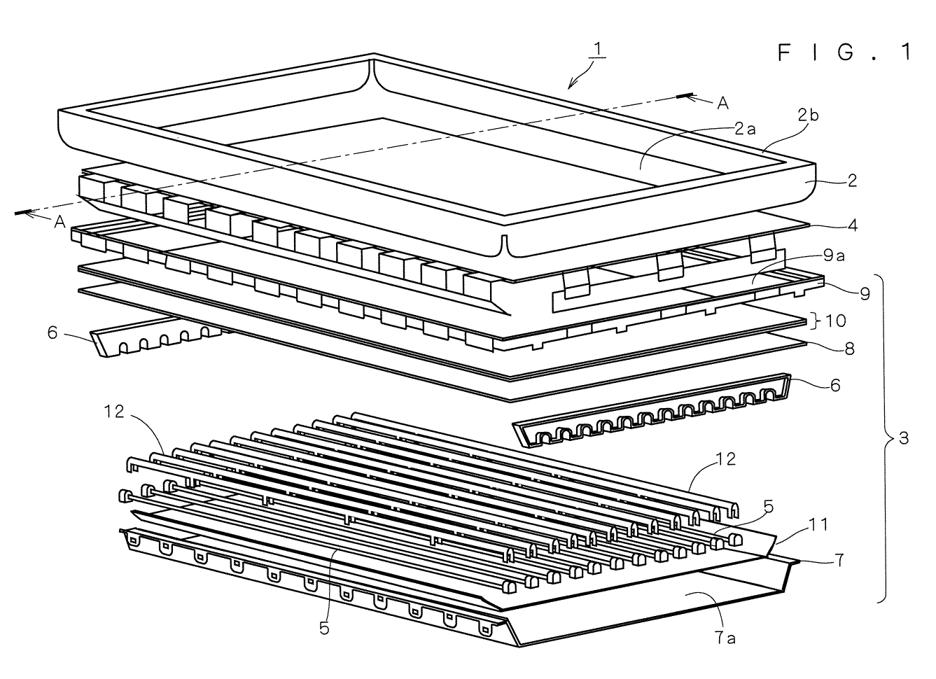

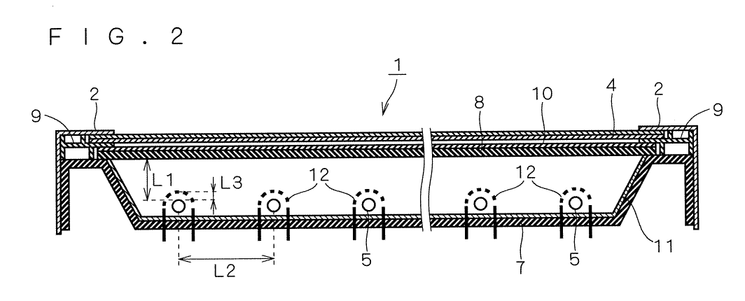

FIG. 1 is an exploded perspective view roughly illustrating the structure of a liquid-crystal display apparatus according to a first preferred embodiment, and FIG. 2 is a cross-sectional view of the liquid-crystal display apparatus. FIG. 2 corresponds to the cross section taken along line A-A in FIG. 1, and the same reference characters in FIGS. 1 and 2 denote the corresponding components.

As shown in FIG. 1, the liquid-crystal display apparatus 1 of this preferred embodiment chiefly includes a front frame 2 made of metal, a direct-type backlight unit 3 as a plane light-source device, and a rectangular plate-like liquid-crystal panel 4 held between them. For the sake of convenience of explanation, the display surface side of the liquid-crystal display apparatus 1 is herein defined as the upper side.

The front frame 2 has a rectangular opening 2a corresponding to the display area of the liquid-crystal panel 4, and a frame-like horizontal member 2b surrounding the opening 2a.

The liquid-crystal panel 4 includes a liquid-crystal material sandwiched between two transparent insulating substrates (hereinafter referred to simply as “substrates”). Though not shown graphically, a color layer, light-blocking layer, thin-film transistors (TFTs) as active elements, pixel electrodes, opposing electrode, and interconnections are formed on the upper or lower substrate.

The liquid-crystal panel 4 can be of the conventional VA (Vertical Alignment) type in which liquid-crystal molecules are driven by an electric field vertical to the display surface generated with a pixel electrode formed on one substrate and an opposing electrode (common electrode) formed on the other substrate, or it can be of the In-Place-Switching (IPS) type in which liquid-crystal molecules are driven by an electric field parallel to the display surface generated with a pixel electrode and opposing electrode both formed on one substrate.

The liquid-crystal panel 4 further includes a spacer for holding the two substrates at an equal interval, a sealing material for bonding the substrates together, an end-sealing material for sealing after the introduction of liquid crystal between the two substrates, an alignment layer for forming initial alignment of the liquid crystal, a polarizer for polarizing light, and so on.

The backlight unit 3 includes a plurality of lamps 5, a pair of supporting members 6 for supporting them together, a plurality of metal covers 12 for respectively covering the lamps 5, a rear frame 7 disposed under the lamps 5, a diffuser 8 and an optical sheet 10 disposed above the lamps 5, and a mold frame 9 made of resin such as polycarbonate (PC).

The plurality of lamps 5 can be cold-cathode tubes, for example, and they are fixed in the rear frame 7 by the supporting members 6. The lamps 5 are arranged in parallel to the diffuser 8, and in parallel to each other.

In this preferred embodiment, the rear frame 7 that accommodates the lamps 5 is made of metal material with high rigidity, such as aluminum, stainless steel, iron, brass, magnesium alloy, or the like. The rear frame 7 functions also to reflect the light emitted from the lamps 5 toward the diffuser 8 above the lamps 5. Accordingly, the rear frame 7 is disposed such that its bottom 7a faces toward the diffuser 8 with the lamps 5 interposed between them, and a reflecting sheet 11 is provided on its inner surfaces (on the bottom 7a and side walls) to reflect the light (specular reflection, diffuse reflection, or combination thereof). Examples of the reflecting sheet 11 include: a plastic sheet with high reflectance (a high-reflectance plastic sheet); a plastic sheet with high-reflectance particles such as barium oxide added thereto; a plastic sheet having a high-reflectance coating on its surface; and a metal plate with high reflectance (aluminum, silver, or the like). In order to reduce light loss, it is desirable that the reflecting sheet 11 have as high a reflectance as possible, and it is more desirable that the reflecting sheet 11 have a reflectance of 95% or more.

In the backlight unit 3, the diffuser 8 and the optical sheet 10 provided above the lamps 5 are held between the rear frame 7 and the mold frame 9. The mold frame 9 has an opening 9a to pass the light transmitted through the diffuser 8 and the optical sheet 10, and the opening 9a has an area approximately equal to that of the liquid-crystal panel 4.

The diffuser 8 diffuses and transmits light from the lamps 5 (direct light from the lamps 5 and reflected light from the reflecting sheet 11), and it is capable of uniformly radiating the light, even obliquely incident light, in all directions without irregularities. The diffuser 8 is made of resin that contains light scattering material mixed therein (e.g. acrylic resin, polycarbonate, etc.). Also, the diffuser 8 is positioned to entirely cover the opening 9a of the mold frame 9 so that the radiated light uniformly spreads at the display surface of the liquid-crystal panel 4. Two or more diffusers 8 may be used in combination to obtain enhanced diffusivity.

The optical sheet 10 is provided above the diffuser 8 to effectively utilize the light passed through the diffuser 8. The optical sheet 10 is composed of a lens sheet (a prism sheet or a polarizing reflection sheet) for collecting light into desired directions, or a protective sheet. A plurality of sheets may be used in combination when needed, or the optical sheet 10 can be omitted when it is not needed.

As shown in FIGS. 1 and 2, the backlight unit 3 of this preferred embodiment has the metal covers 12 between the lamps 5 and the diffuser 8. The metal covers 12 are provided to control the amounts of light, heat, and electromagnetic waves that are generated by the lamps and propagate upward (in directions toward the diffuser 8).

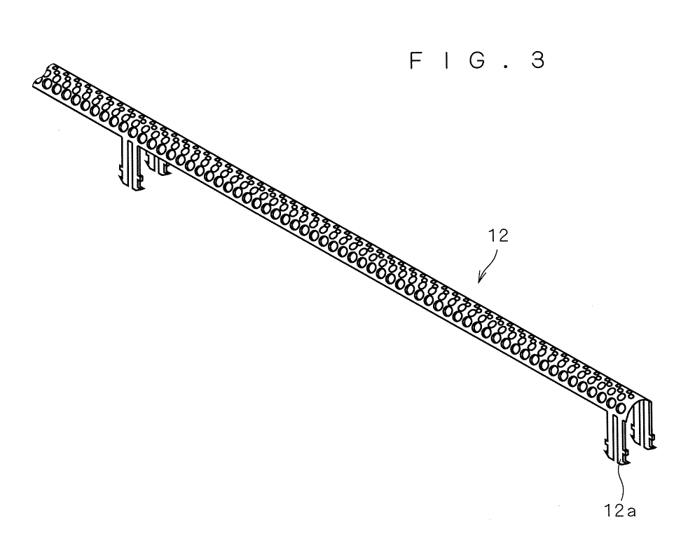

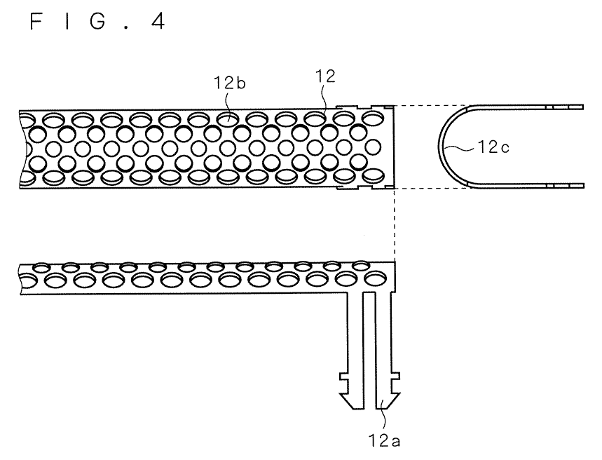

FIG. 3 is a perspective view of a metal cover 12, and FIG. 4 is a three-view drawing thereof. As shown in FIGS. 3 and 4, the metal cover 12 has a large number of through holes 12b. The metal covers 12 have an external diameter larger than the diameter of the lamps 5 (generally, around 2 to 5 mm) so that they can respectively cover the lamps 5.

The metal cover 12 has legs 12a formed in some positions, and the metal cover 12 is fixed to the rear frame 7 by fitting the legs 12a in holes (not shown) formed in the rear frame 7. Snap-fit is applied to each of the legs 12a to prevent them from becoming detached.

This preferred embodiment adopts snap-fit to fix the metal covers 12 and the rear frame 7, in order to facilitate the assembly of the backlight unit 3 and to reduce the number of parts, but they can be fixed by other means, e.g. by screws.

As mentioned above, the metal covers 12 serve to control the amounts of light, heat and electromagnetic waves generated by the lamps and traveling upward (in directions toward the diffuser 8), and these functions will now be specifically described.

Each metal cover 12 has high reflectance at least at its surface 12c that faces the lamp 5 (a lamp-side surface) so that it can reflect light from the lamp 5 (a light reflecting function). For example, a high-reflectance plastic sheet may be bonded on the lamp-side surface 12c, or a high-reflectance coating may be applied thereto. The lamp-side surface 12c of the metal cover 12 reflects part of the light emitted upward from the lamp 5, so as to suppress the amount of direct light propagating from the lamp 5 to reach the diffuser 8. Also, the light reflected at the lamp-side surface 12c is reflected at the reflecting sheet 11 (or repeatedly reflected several times) and travels upward at all angles. Accordingly, the light from the lamps 5 is more diffused than in conventional ones, and a lamp image is less likely to appear at the light-emission surface of the diffuser 8.

The metal covers 12 have high heat conductivity and absorb heat generated by the lamps 5. Furthermore, the metal covers 12 are connected to the rear frame 7, made of metal, through the legs 12a, so that the heat absorbed by the metal covers 12 is dissipated to the rear frame 7 (a heat dissipating function). That is, the legs 12a function to dissipate heat from the lamps 5 to the rear frame 7, as well as to fix the metal covers 12 in given positions. This allows less heat to propagate upward from the lamps 5 than in conventional ones, and suppresses the temperature elevation in the backlight unit 3 itself.

Furthermore, the metal covers 12 are electrically conductive, so that they can block electromagnetic waves generated by the lamps 5 (an electromagnetic wave blocking function). This reduces the amount of upward radiation (in directions toward the liquid-crystal panel 4) of electromagnetic waves generated by the lamps 5, as compared with conventional ones.

Moreover, in this preferred embodiment, the metal covers 12 prevent the lamps 5 from being deformed by external forces, and thus prevent breakage of the lamps 5.

Referring to FIG. 2 again, the effects of this preferred embodiment offered by these functions of the metal covers 12 will be described specifically. In FIG. 2, the distance L1 indicates the interval between the lamps 5 and the diffuser 8, the distance L2 indicates the interval between adjacent lamps 5 (lamp pitch), and the distance L3 indicates the interval between the metal covers 12 and the lamps 5.

As mentioned earlier, in conventional direct-type backlights, shortening the distance L1 between the lamps 5 and the diffuser 8 causes a lamp image to appear at the light-emission surface of the diffuser 8, and also causes the diffuser 8 to be warped, yellowed and deformed by the heat from the lamps 5, resulting in deterioration of light-emission quality of the backlight unit 3. Also, shortening the distance L1 shortens the distance between the lamps 5 and the liquid-crystal panel 4, and then the liquid-crystal panel 4 is more likely to be affected by heat and electromagnetic waves from the lamps 5, resulting in deterioration of display quality.

In contrast, according to this preferred embodiment, the metal covers 12 function to sufficiently diffuse light from the lamps 5, dissipate heat from the lamps 5 to the rear frame 7, and block electromagnetic waves generated from the lamps 5. Accordingly, the above-mentioned problems are less likely to occur even when the distance L1 is reduced. It is therefore possible to reduce the distance L1 to reduce the thickness of the backlight unit 3, hence to reduce the thickness of the liquid-crystal display apparatus, while maintaining the light-emission quality of the backlight unit 3 and the display quality of the liquid-crystal panel 4.

In other words, according to this preferred embodiment, it can be said that a lamp image is less likely to appear at the diffuser 8 and the light-emission quality is less likely to deteriorate even when the lamp pitch L2 is enlarged. That is, it is also possible to reduce the number of lamps 5 to reduce the amounts of generated heat and electromagnetic waves, while maintaining high light-emission quality.

When the lamp pitch L2 is around 13 to 30 mm, conventional direct-type backlights (those used in commercially available liquid-crystal display apparatuses) require that the distance L1 be at least about 22 mm to prevent the synthetic-resin diffuser from being affected by heat from the lamps, but this preferred embodiment can reduce it to 10 mm or less. Also, when the current to the lamps 5 (consumed power) is small, the distance L1 can be shortened because the lamps 5 generate less heat and less electromagnetic waves. Also, the lamp image is less likely to be visually recognized when the lamp pitch L2 is reduced, and then the distance L1 can be reduced. In this case, the distance L1 can be about 1.5 mm to 5 mm, which allows considerable reduction of the thickness as compared with conventional ones. Also, heat and electromagnetic waves from the lamps 5 can be efficiently absorbed by setting the distance L3 between the metal covers 12 and the lamps 5, shown in FIG. 2, to not less than 0.4 mm nor more than 2.0 mm.

As described so far, according to this preferred embodiment, the metal covers 12 restrict the amount of direct light propagating from the lamps 5 to reach the diffuser 8, and the metal covers 12 offer the light reflecting function to diffuse the light from the lamps 5. Therefore, a lamp image is less likely to appear at the light-emission surface of the diffuser 8 and the light-emission quality is kept high even when the distance between the diffuser 8 and the lamps 5 is shortened. This makes it possible to reduce the thickness of the backlight unit 3.

The metal covers 12 offer the heat dissipating function to dissipate heat from the lamps 5 to the rear frame 7, to suppress upward conduction of heat. Accordingly, the diffuser 8 is less likely to be warped, yellowed, or deformed by the heat from the lamps 5 even when the distance between the diffuser 8 and the lamps 5 is reduced, or when the number of lamps 5 is increased, and the light-emission quality is kept high. Also, the temperature elevation in the backlight unit 3 itself is suppressed, and so the temperature gradient in the liquid-crystal panel 4 is suppressed, and thus deterioration of display quality is suppressed.

The metal covers 12 offer the electromagnetic wave blocking function to prevent the liquid-crystal panel 4 from being affected by electromagnetic waves generated by the lamps 5, even when the distance between the liquid-crystal panel 4 and the lamps 5 is reduced, which prevents deterioration of the display quality. This contributes to the reduction of thickness of the liquid-crystal display apparatus 1.

Also, the metal covers 12 prevent the lamps 5 from being deformed by external forces, and thus prevent breakage of the lamps 5 on drop impact, so as to enhance the strength of the backlight unit 3.

Preferably, the diameter of the through holes 12b of the metal covers 12 is set in the range of 0.5 mm to 3 mm, and more preferably in the range of 1 mm to 2 mm. This is because it is difficult to precisely form small holes with a diameter smaller than 0.5 mm by machining, and it is also difficult to control display non-uniformity and to sufficiently block electromagnetic waves with large holes having a diameter larger than 3 mm. The thickness of the metal covers 12 is determined to ensure stiffness and maintain shape, and it is preferably from 0.1 mm to 0.5 mm. The shape of the through holes 12b is not limited to the circular shape, but the same effects are obtained with elongated holes, oval holes, rectangular holes, triangular holes, etc.

The metal covers 12 are made of material having high heat conductivity and electromagnetic wave blocking property to provide the effects described above, and the metal covers 12 may be made of, instead of metal material, resin material with metal particles mixed therein, for example.

This preferred embodiment uses linear light sources as the lamps 5, such as cold-cathode tubes or hot-cathode tubes, but point light sources such as light-emitting diodes may be used as long as sufficient luminance is obtained, in which case a plurality of point light sources can be arranged along the length direction of the rear frame 7 to obtain the same effects as those obtained with linear light sources. In this case, it is desirable to appropriately adjust and optimize the shape of the metal covers 12 and the positions, density and size of the through holes 12b according to the positions, density and size of the point light sources.

### Second Preferred Embodiment

This preferred embodiment illustrates a modification of the metal covers 12 for covering the lamps 5.

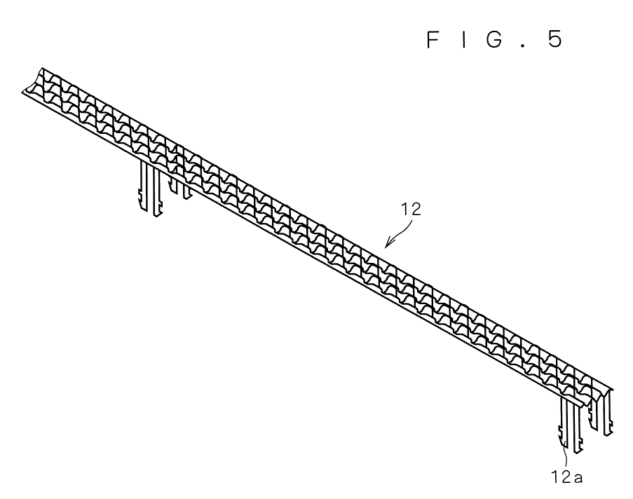

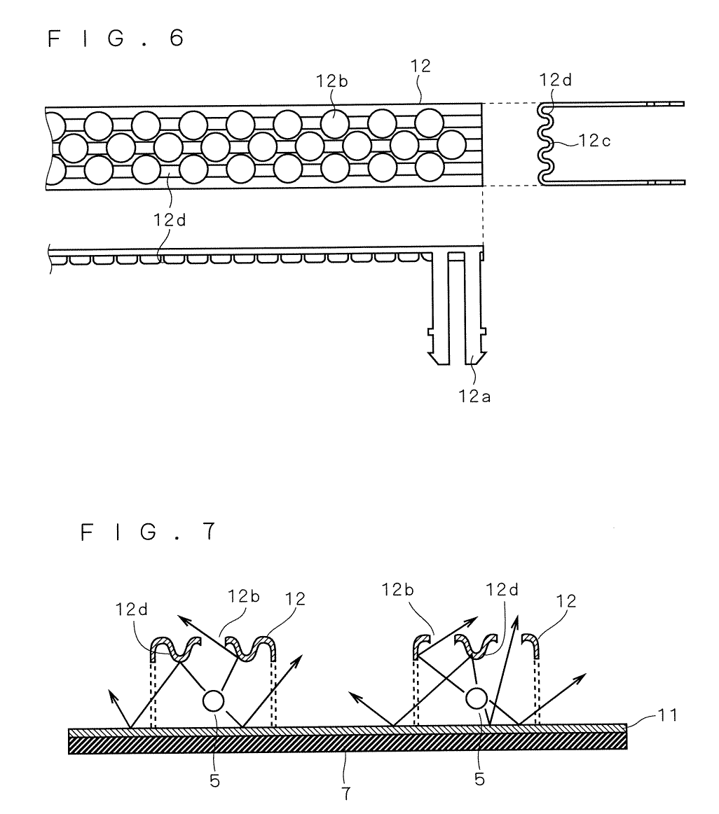

FIG. 5 is a perspective view of a metal cover 12 according to a second preferred embodiment, and FIG. 6 is a three-view drawing thereof. As can be seen from the diagrams, the metal cover 12 of the second preferred embodiment is smoothly corrugated approximately like a sine wave in the direction perpendicular to the lamps 5. Shaped in this way, the metal cover 12 has tapered projections 12d on its lower surface (on the lamp-side surface 12c). The structure is the same as that of the first preferred embodiment except for the corrugated shape of the metal cover 12. That is, the metal cover 12 of the second preferred embodiment also has legs 12a for engagement with the rear frame 7 and a large number of through holes 12b, and its lamp-side surface 12c has high reflectance. That is, this metal cover 12, too, has the light reflecting function, the heat dissipating function, and the electromagnetic wave blocking function.

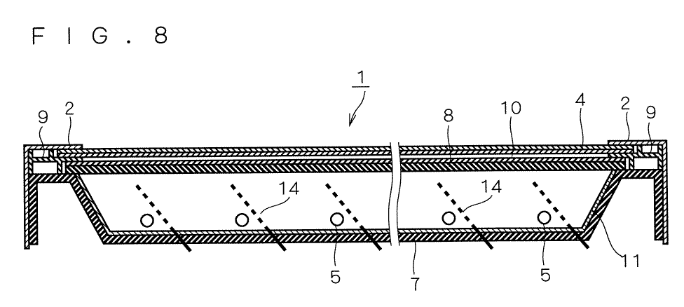

FIG. 7 is a diagram used to illustrate effects of the second preferred embodiment, and it is an enlarged cross-sectional view showing lamps 5, metal covers 12, the rear frame 7, and reflecting sheet 11 of the backlight unit 3. FIG. 7 shows a cross section vertical to the length direction of the lamps 5. The metal covers 12 of this preferred embodiment have the projections 12d on their lower surfaces, so that the light emitted from the lamps 5 is reflected in all directions as shown in FIG. 7. As a result, the light is diffused more uniformly than in the first preferred embodiment, and the efficiency of utilization of light is further enhanced. This prevents the occurrence of a lamp image at the light-emission surface of the diffuser 8 and provides high luminance, thus enhancing the light-emission quality.

In this preferred embodiment, too, the diameter of the through holes 12b of the metal covers 12 is preferably in the range of 0.5 mm to 3 mm, and more preferably in the range of 1 mm to 2 mm.

### Third Preferred Embodiment

FIG. 8 is a cross-sectional view of a liquid-crystal display apparatus according to a third preferred embodiment. As shown in this diagram, in this preferred embodiment, the metal covers 12 of the first preferred embodiment are replaced by metal covers 14 that are each formed like a flat-plate cantilever (hereinafter referred to as “cantilever-like covers 14”). As shown in FIG. 8, the cantilever-like covers 14 are fixed at an inclination to cover the lamps 5.

The cantilever-like covers 14, too, each have a large number of through holes and legs for engagement with the rear frame 7, and they have high reflectance at their lamp-side surfaces. That is, like the metal covers 12 of the first preferred embodiment, the cantilever-like covers 14 also have the light reflecting function, the heat dissipating function, and the electromagnetic wave blocking function, and thus provide the same effects as those of the first preferred embodiment. The cantilever-like covers 14 shaped like flat plates are advantageous in that they are easy to form. Alternatively, the second preferred embodiment may be applied to the cantilever-like covers 14, in which case the cantilever-like covers 14 are corrugated such that their lamp-side surfaces form irregularities. This allows the cantilever-like covers 14 to more efficiently diffuse light from the lamps 5.

In this preferred embodiment, too, the diameter of the through holes of the cantilever-like covers 14 is preferably in the range of 0.5 mm to 3 mm, and more preferably in the range of 1 mm to 2 mm.

While the invention has been described in detail, the foregoing description is in all aspects illustrative and not restrictive. It is understood that numerous other modifications and variations can be devised without departing from the scope of the invention.

What is claimed is:

1. A plane light-source device comprising:
a plurality of lamps;
a diffuser that diffuses light from said lamps;
covers disposed between said diffuser and said lamps and respectively covering said plurality of lamps; and
a rear frame disposed in a position that faces toward said diffuser with said lamps interposed therebetween;
said rear frame being made of a metal material, and
said covers being made of a metal material or a resin material with metal particles mixed therein, said covers each having a plurality of through holes and being fixed to said rear frame.

2. The plane light-source device according to claim 1, wherein said covers are capable of reflecting light from said lamps at their respective surfaces that face said lamps.

3. The plane light-source device according to claim 1, wherein said covers each have irregularities on their respective surfaces that face said lamps.

4. The plane light-source device according to claim 1, wherein each said cover is corrugated.

5. The plane light-source device according to claim 1, wherein said through holes of said covers have a diameter in the range of 0.5 mm to 3.0 mm.

6. The plane light-source device according to claim 1,
wherein said rear frame has holes to fix said covers, and
said covers are fixed by fitting their portions in said holes.
